(19) United States
(12) Patent Application Publication
(10) Pub. No.: US 2009/0214742 A1
(43) Pub. Date: Aug. 27, 2009

(54) DEVICE AND METHOD FOR PREPARING AROMATIC HOT DRINKS, PARTICULARLY COFFEE AND TEA

(75) Inventors: Ray Peden, Everett, WA (US); Roman Probst, Seattle, WA (US)

Correspondence Address: VOLPE AND KOENIG, P.C., UNITED PLAZA, SUITE 1600, 30 SOUTH 17TH STREET, PHILADELPHIA, PA, 19103, US

(73) Assignee: NIRO-PLAN AG, Aarburg (CH)

(21) Appl. No.: 12/201,009

(22) Filed: Aug. 29, 2008

(30) Foreign Application Priority Data
Aug. 29, 2007 (DE) 10 2007 041 022.2

(51) Int. Cl. A23L 2/52; B67D 5/56; B67D 5/08; B67D 5/63

(52) U.S. Cl. 426/590; 222/129; 222/64; 222/146.2

(57) ABSTRACT

A device (1) for preparing aromatic hot drinks, particularly coffee, milk, tea, or mixed drinks, with a device (2) for preparing the hot drink, having a first outlet (5), via which the hot drink can be dispensed into a receiving vessel (6), such as a cup, a mug, or the like, is provided with at least one second outlet (14.1, 14.2), fluidly separated from the first outlet (5), that is connected to at least one reservoir (8.1, 8.2) for aromatic substances for dispensing at least one aromatic substance (9.1, 9.2), particularly a syrup, into the receiving vessel (6).

### CROSS-REFERENCE TO RELATED APPLICATIONS

This application claims the benefit of German Application 10 2007 041 022.2, filed Aug. 29, 2007, which is incorporated herein by reference as if fully set forth.

### BACKGROUND

The present invention relates to a device for preparing aromatic hot drinks, particularly coffee, milk, tea, or mixed drinks, using a device for preparing a hot drink, which is provided with a first outlet, via which the hot drink can be dispensed into an receiving vessel, such as a cup, a mug, or the like.

Furthermore, the present invention relates to a device for preparing aromatic hot drinks, particularly coffee, milk, tea, or mixed drinks.

Aromatic hot drinks, particularly coffee, with aromatic substances added in the form of syrups are generally known and are very popular. Generally, here the hot drink is prepared in a respective hot drink—preparation device, such as an automatic coffee maker, and then during the dispensing process it is mixed with the desired aromatic substance and, if applicable, additional hot drink additives, such as milk, milk foam, or the like.

An automatic aromatic agent dosing device is known from WO 2006/135864 A2 for an aromatic espresso machine, in which a mixing chamber is provided equipped with two inlets, with one inlet being connected to a milk pump and another inlet with a reservoir for aromatic substances. Foamed milk is mixed with an aromatic substance in a mixing chamber, and the foamed and aromatic milk created in this manner is then dispensed via an outlet into an receiving vessel, which can be filled via another outlet together with the prepared coffee (espresso). Here, particularly in the area of the mixing chamber, based on the high temperatures existing here and the regularly present sugar components of the added aromatic substances the risk develops that residue or contaminations develop during operation which later can be removed with great expense only.

### SUMMARY

The invention is based on the object to provide a device and a method of the type respectively shown at the outset which is characterized during operation in a particularly easy operation, especially with regard to maintenance and cleaning tasks.

The object is attained in a device having the features of the invention.

Advantageous further embodiments of the device according to the invention are included in the description by explicit reference, in order to avoid unnecessary repetitions of the text.

According to the invention, a device for preparing aromatic hot drinks, particularly coffee, having a device for preparing the hot drink provided with a first outlet, via which the hot drink can be dispensed into an receiving vessel, such as a cup, a mug, or the like, is characterized in at least one second outlet, which is separated from the first outlet by fluid technology, and which for dispensing at least one aromatic substance, particularly a syrup, into the receiving vessel is connected in fluid communication to at least one reservoir for aromatic substances

Furthermore, a method for preparing aromatic hot drinks, particularly coffee, using the device according to the invention is characterized in that the hot drink and, if applicable, additional additives of hot drinks can be dispensed via the first and/or if applicable a third outlet into the receiving vessel and in that an aromatic substance is dispensed into the receiving vessel prior thereto and/or simultaneously and/or thereafter via the second outlet.

The principle features of the present invention therefore comprises that a separate outlet is provided, via which exclusively aromatic substances, for example in the form of a syrup, are dispensed into the receiving vessel, while via another outlet the prepared hot drink and/or, in another further embodiment of the invention, additional additives for the hot drink, such as milk or milk foam, are dispensed. The present invention particularly differs from the prior art described at the outset such that the mixing of milk and aromatic substances represents the basic idea, here. In this way, the present invention achieves an improved ease of operation particularly with regard to maintenance and cleaning tasks.

Further developments of the device according to the invention provide that they are provided with a multitude of reservoirs or containers for aromatic substances, each of which containing (different) aromatic substances. For each aromatic substance and/or each reservoir of aromatic substances a separate second outlet is provided to dispense said aromatic substance into the receiving vessel. The aromatic reservoirs can be embodied particularly as tubular bags or the like.

In order to transport the respective aromatic substance it is provided, in a further embodiment of the device according to the invention, such that it includes a pumping device connected to each secondary outlet. The pumping device can be particularly embodied as CO₂-pumps, without limiting the present invention thereto.

In order to transport and/or dosage the aromatic substances another further embodiment of the device according to the invention provides that each pumping device can be controlled independent from the other pumping devices, particularly by a master control unit of the device.

For this purpose, another further embodiment of the device according to the invention provides that for a controlled dispensing of the aromatic substance and/or the aromatic substances a switch-valve arrangement is provided between a respective reservoir for aromatic substances and the corresponding outlet. According to another embodiment, for each aromatic substance said (arrangement) can be provided with a corresponding switching arrangement, which is embodied to open and/or interrupt the supply of the aromatic substance. The control of the switching arrangement preferably occurs depending on the fill-level of the respective reservoir for the aromatic substance, particularly using a vacuum sensor. For example, it may be provided that the switching arrangement for a certain aromatic substance interrupts its supply and/or a corresponding connection when the fill level drops below a predetermined level (so-called sold-out switch). Furthermore, the switching arrangement can be connected via signal technology to the above-mentioned control unit, e.g., in order display a respective warning signal and/or to block product dispensing an aromatic substance when said an aromatic substance is unavailable.

Another embodiment of the device according to the invention provides that the switch-valve arrangement additionally is provided with a valve allocated to each aromatic substance to dispense the respective aromatic substance via the respective second outlet. For a dosed dispensing of the respective aromatic substance the valves are also connected to the above-mentioned control unit in a signal-technologically effective manner.

According to a respective further development of the device according to the invention it is provided that the valves mentioned are embodied as magnetic spool valves. Furthermore, it can be provided that each valve can be controlled independent from the other valves, particularly by the above-mentioned control unit of the device.

Due to the fact that during the preparation of aromatic hot drinks regularly additional additives for hot drinks, such as milk, milk foam, or the like are dispensed, another embodiment of the device according to the invention provides that they are provided with a third outlet, which is separated from the first and second outlets by fluid technology, and via which the above-mentioned further additives for hot drinks can be dispensed. In this way, a separate outlet is provided for each component of the hot drink, which considerably facilitates the operating comfort of the device, particularly with regard to maintenance and cleaning tasks.

Alternatively, it may be provided, though, that the above-mentioned further additives for the hot drinks are dispensed via the same outlet as the prepared hot drink.

The scope of the present invention also covers embodiments of the device according to the invention such that, additionally or alternatively to preparing hot drinks, it serves to prepare cold drinks. Therefore, the device for preparing aromatic hot and/or cold drinks, particularly coffee, milk, tea, or mixed drinks may be provided with a device for preparing the hot and/or the cold drink having a first outlet, via which the hot and/or cold drink can be dispensed into an receiving vessel, such as a cup, a mug, or the like, and with at least one second outlet, which is separated from the first outlet by fluid technology, and which is connected by fluid technology to a reservoir for an aromatic substance for dispensing at least one aromatic substance, particularly a syrup, into the receiving vessel. Other embodiments of this embodiment are discernible from the appended claims. In addition to these embodiments another outlet may be provided, serving to dispense particularly frozen liquids or foods, such as ice cubes, crushed ice, ice cream, or fruit pulp into the receiving vessel, and which is connected to at least one reservoir of frozen liquids or foods. The other outlet can also serve to provide an outlet for cold drinks in addition to the outlet for hot drinks so that via the same device optionally hot or cold drinks can be prepared without any retrofitting tasks.

### BRIEF DESCRIPTION OF THE SEVERAL VIEWS OF THE DRAWINGS

Additional features and advantages of the present invention are discernible from the following description of exemplary embodiments using the drawings. Shown are:

FIG. 1 is a schematic overall view of an embodiment of the device according to the invention for preparing aromatic hot drinks; and

FIG. 2 is a detailed view of a switch-valve arrangement in the device according to FIG. 1.

### DETAILED DESCRIPTION OF THE PREFERRED EMBODIMENTS

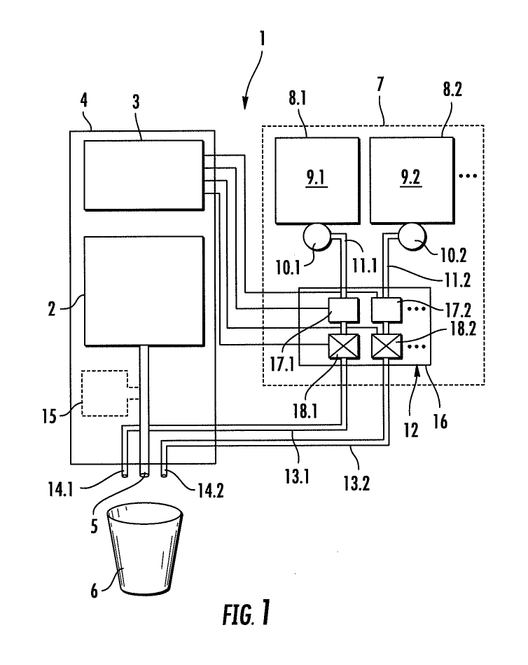

Using a schematic overall view, FIG. 1 shows an embodiment of the device 1 according to the invention to prepare aromatic hot drinks, particularly coffee.

The device 1 is first provided with an installation 2 to prepare a hot drink, which here is illustrated schematically as a block only, in practice however it can be embodied particularly as a fully-automated coffee maker comprising a mill, brewing unit, coffee bean storage container, water tank or connector, and the like, which is known to one trained in the art, so that here the details of installation 2 require no detailed discussion. During operation, the installation 2 cooperates with a control unit 3, and usually it is arranged together with it inside a housing 4. The installation 2 for preparing a hot drink is provided with a first outlet 5, via which the hot drink can be dispensed into an receiving vessel 6, for example a cup or a mug. For this purpose, the receiving vessel 6 is placed either manually or automatically underneath said first outlet 5.

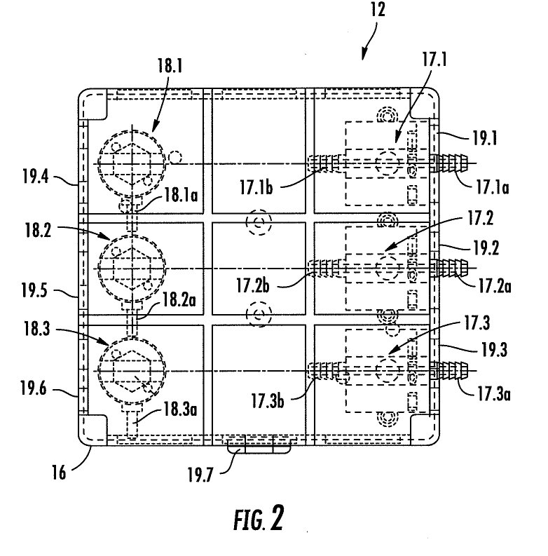

In order to deliver the hot drink, particularly coffee, in different taste variations upon request, i.e. aromatic, the device 1 is further provided with an aromatic substance storage and dosing device 7, as shown symbolically in a box drawn in dashed lines in FIG. 1. The aromatic substance storage and dosing device 7 is provided with a number of aromatic substance containers (e.g., tubular bags) 8.1, 8.2, only two of which being shown for reasons of clarity. The aromatic substance containers 8.1, 8.2 each contain a (different) aromatic substance 9.1, 9.2 in the form of a syrup-like liquid, for example a caramel, vanilla, or chocolate aroma, without any limitation thereto. In order to dosage and/or transport the aromatic substance 9.1, 9.2 each aromatic substance container 8.1, 8.2 is connected to a pump 10.1, 10.2, which can be embodied particularly as a CO₂-pump. From the pumps 10.1, 10.2 one line 11.1, 11.2 each, which may be embodied as a plastic pipeline, leads to a switch-valve arrangement 12, discussed in greater detail in the following using FIG. 2. Beginning at the switch-valve arrangement 12, separate lines 13.1, 13.2 for each of the aromatic substances 9.1, 9.2 lead to the housing 4 of the hot drink—preparation installation 2, at which they are arranged in the proximity of the first (hot drink)-outlet 5 in the form of additional (second) outlets 14.1, 14.2, via which the prepared hot drink, leaving the first outlet 5 can be added in a targeted manner to a certain aromatic substance 9.1, 9.2 or which can be added to an arbitrary mixture of stored aromatic substances 9.1, 9.2 directly in the receiving vessel 6. Depending on the desired form of preparation, here the dispensing of the aromatic substance or the aromatic substances 9.1, 9.2 can occur via the second outlets 14.1, 14.2 before and/or during and/or after the dispensing of the hot drink via the first outlet 5.

As already mentioned the present invention is not limited to the provision of two aromatic substance containers 8.1, 8.2 with the respective transportation and/or dosing installations. Furthermore, the first outlet 5 for the prepared hot drink and the second outlets 14.1, 14.2 for the aromatic substances 9.1, 9.2 to be dosed can be arranged in any arbitrary geometry in reference to each other, as long as the dispensing of the hot drink and/or the aromatic substances into the receiving vessel 6 is ensured.

A preferred further embodiment of the device 1 according to the invention, not shown in FIG. 1, provides accordingly that at both sides of the first outlet 5 a multitude of second outlets 4.1, 4.2 is arranged behind each other (into the plane of the sheet). Alternatively, in particular a circular or annular arrangement of second outlets 4.1, 14.1, 14.2 around the first outlet 5 is also possible.

The present invention is not restricted to the arrangement schematically shown in FIG. 1 with regard to the spatial arrangement of the hot drink—preparation installation 2 and/or the housing 4 and the aromatic substance storage and dosing device 7 in reference to each other. Although particularly the containers 8.1, 8.2 for the aromatic substances are advantageously provided outside the housing 4, particularly together with the pumps 10.1, 10.2 in a type of frame or rack system (not shown), the provision inside a common housing (not shown) is also possible, for example when a fully automated self-service apparatus is to be provided. The switch-valve arrangement 12, to be discussed in greater detail in the following, not necessarily requires a spatial arrangement in the proximity of the containers 8.1, 8.2 of the aromatic substances and the pumps 10.1, 10.2. Rather, it is also possible within the scope of the present invention to provide the switch-valve arrangement 12 inside the housing 4 or in a refrigerated container (not shown) for milk or other additives and here to connect it via the lines 11.1, 11.2 to the containers 8.1, 8.2 for aromatic substances arranged outside the housing 4 or the refrigerated container as well as the pumps 10.1, 10.2.

The lines 13.1, 13.2 can be embodied as tubular hoses similar to the lines 11.1, 11.2. Alternatively and/or additionally the lines 13.1, 13.2 are however produced from stainless steel or the like, particularly in the area of the second outlets 14.1, 14.2 as well as the first outlet 5, for hygienic and/or esthetic reasons.

Furthermore, FIG. 1 schematically shows with the reference character 15 a device for the preparing and dispensing additional hot drink additives, such as mild, milk foam, or the like. Deviating from the illustration in FIG. 1, it can also be arranged outside the housing 4, in principle. The function and the general embodiment of the device 15 are known to one trained in the art, so that it is not discussed in greater detail, here. The device 15 can alternatively also be integrated in the hot drink—preparation device 2. According to the illustration in FIG. 1, the device 15 for dispensing the additional hot drink additive and/or additives is/are connected to the first outlet 5, so that the hot drink prepared and the other hot drink additive and/or additives are mixed prior to dispensing and then are dispensed jointly via the first outlet 5.

However, alternatively it is also possible for the additional hot drink additive and/or additives to be provided via another third outlet (not shown), connected to the device 15, so that then in a modification of the illustration according to FIG. 1, the prepared hot drink, the aromatic substance or substances 9.1, 9.2, and the other hot drink additive or additives each can be dispensed into the receiving vessel 6 via separate outlets.

Based on a detailed illustration from the bottom, FIG. 2 shows an embodiment of the switch-valve arrangement 12 in FIG. 1. Deviating from the illustration in FIG. 1, the switch-valve arrangement 12 according to FIG. 2 is provided with an arrangement to transport and/or dosage three (different) aromatic substances via respective dosing and/or transportation devices. Except for this difference, the reference characters in FIG. 2 are equivalent to the ones in FIG. 1.

Accordingly, the switch-valve arrangement or valve box 12 is provided with a housing 16 in the form of a junction box. Inside the housing 16, on one side a number of (identical) switching devices 17.1, 17.2, 17.3 are arranged. The switching devices 17.1, 17.2, 17.3 are provided with connection devices 17.1a, 17.2a, 17.3a to connect the (tubular) connections to the containers 8.1, 8.2 of the aromatic substances and/or the pumps 10.1, 10.2 (cf. FIG. 1). At the respectively other side, the switching devices 17.1-17.3 are provided with respective connecting elements 17.1b, 17.2b, 17.3b, via which the switching devices 17.1-17.3 can be connected to allocated valves 18.1, 18.2, 18.3 via fluid-technology components, which are provided on the opposite side of the housing 16 of the switch-valve arrangement 12. Then, from the valves 18.1-18.3, the (tubular) lines 13.1, 13.2 lead to the second outlets 14.1, 14.2, as shown in FIG. 1 and explained above in greater detail. The valves 18.1-18.3 are embodied here as magnetic spool valves and each show control connectors 18.1a, 18.2a, 18.3a, via which they can be connected to the control unit 3 (FIG. 1), which is shown schematically in FIG. 1. Similarly, the switching devices 17.1-17.2 can be connected via control-technology components, such as wires or wireless signal carriers, to the control unit 3 (FIG. 1), which is also shown schematically in FIG. 1.

The housing 16 of the switch-valve arrangement 12 is provided with a number of penetrations 19.1-19.6 for (tubular) connections 11.1, 11.2, 13.1, 13.2, passing through them as described above in FIG. 1, which connect the switch-valve arrangement 12 to the aromatic substance containers 8.1, 8.2 and/or the pumps 10.1, 10.2, on the one hand, and the second outlets 14.1, 14.2, at the other hand, with again only two such connections being shown in FIG. 1. Another penetration 19.7, located at the other side of the housing 16 than the penetrations 19.1-19.3 and/or 19.4-19.6, is embodied as a cable guiding socket, via which the control lines for connecting to a control unit 3 (FIG. 1) are guided in the form of a wiring harness, which is not shown in detail, neither in FIG. 1 nor in FIG. 2.

The switching devices 17.1-17.2 are presently embodied with a so-called sold-out switch of the name brand Flojet®, however, other equivalent switching devices can also be used. They determine via sensors, for example via a vacuum sensor, if and/or when a reservoir for aromatic substances connected to the connecting elements 17.1a-c is empty, and then they interrupt the connection and/or transfer a control signal to the control unit 3 (FIG. 1), which can switch the device 1 and/or at least the hot drink—preparation device 2 to an appropriate operational state. Then an error signal is displayed, for example, which urges the operator to refill the respective reservoir for aromatic substances. A respective option can be blocked in a fully-automatic hot drink preparation device.

As stated, the valves 18.1-18.3 can particularly be embodied as magnetic spool valves, and serve according to the control unit 3 (FIG. 1) to transport the respective aromatic substances 9.1, 9.2 in a dosed fashion to provide the desired aromatic hot drink for the receiving vessel 6 (FIG. 1).

In this context well as the other above-described ones, respective input and output may be provided at the housing 4 in a signal-technology effective connection to the control unit 3, which is known per se to one trained in the art, so that it is not discussed any further here.

In each case, within the scope of the present invention, the aromatic substance or substances 9.1, 9.2 (FIG. 1) are dispensed via separate (second) outlets 14.1, 14.2, separated from the hot drink prepared or, if applicable, additional hot drink additives, such as milk, milk foam, or the like, which during the operation of the device 1 according to the invention, particularly based on the separate outlets, leads to the overall device being embodied in a user friendly manner with regard to maintenance and cleaning.

1. A device (1) for preparing aromatic hot drinks, coffee, milk, or mixed drinks, comprising an installation (2) for preparing a hot drink, provided with a first outlet (5), via which the hot drink can be dispensed into an receiving vessel (6), at least one second outlet (14.1, 14.2), which is separated from the first outlet (5), and is fluidly connected to at least one reservoir for aromatic substances (8.1, 8.2) to dispense at least one aromatic substance (9.1, 9.2) into the receiving vessel (6).

2. A device (1) according to claim 1, wherein another second outlet (14.1, 14.2) and a second reservoir for aromatic substances (8.1, 8.2) is provided so that a plurality of aromatic substances (8.1, 8.2) can be dispensed.

3. A device (1) according to claim 2, further comprising a pumping device (10.1, 10.2) connected to each of the second outlets (14.1, 14.2) to transport the respective aromatic substance (9.1, 9.2).

4. A device (1) according to claim 3, wherein each of the pumping devices (10.1, 10.2) can be controlled independently from one another.

5. A device (1) according to claim 2, wherein a switch-valve arrangement (12) is arranged between the reservoirs (8.1, 8.2) for aromatic substances and the second outlets (14.1, 14.2) for a controlled dispensing of the aromatic substances (9.1, 9.2).

6. A device (1) according to claim 5, wherein the switch-valve arrangement (12) is provided with one switching device (17.1-17.3) for each of the aromatic substances (9.1, 9.2) for opening/interrupting a supply of the aromatic substances, controlled depending on a fill-level of the reservoir (8.1, 8.2) for aromatic substances.

7. A device (1) according to claim 6, wherein the switch-valve arrangement (12) is provided with valves (18.1-18.3) for dispensing the respective aromatic substance (9.1, 9.2) via the respective second outlets (14.1, 14.2).

8. A device (1) according to claim 7, wherein the valves (18.1-18.3) are magnetic spool valves.

9. A device (1) according to claim 8, wherein each of the valves (18.1-18.3) can be controlled independently from the other valves.

10. A device (1) according to claim 1, wherein a third outlet is provided for dispensing additional hot drink additives, which is fluidly separate from the first (5) and the second outlets (14.1, 14.2).

11. A device (1) according to claim 1, wherein the first outlet (5) is additionally embodied to dispense other hot drink additives.

12. A method for preparing aromatic hot drinks, comprising;
dispensing the hot drink via a first outlet and optionally dispensing additional hot drink additives via a third outlet into an receiving vessel (6), and
prior thereto and/or simultaneously and/or subsequently thereto, dispensing at least one aromatic substance (9.1, 9.2) via a second outlet (14.1, 14.2) into the receiving vessel (6).
